(19) United States
(12) Patent Application Publication
(10) Pub. No.: US 2005/0246280 A1
(43) Pub. Date: Nov. 3, 2005

(54) Interactive communication device

(76) Inventor: Bernard Besson, Villaz (FR)

Correspondence Address: WILLIAM H. EILBERG, THREE BALA PLAZA, SUITE 501 WEST, BALA CYNWYD, PA, 19004, US

(21) Appl. No.: 10/512,751

(22) PCT Filed: Apr. 2, 2003
(86) PCT No.: PCT/FR03/01031

§ 371 Date: Oct. 27, 2004

(30) Foreign Application Priority Data
Apr. 3, 2002 (FR) 02/04367

(51) Int. Cl. G06F 17/60; H04L 9/00

(52) U.S. Cl. 705/51

(57) ABSTRACT

A server system (1) is connected to a number of remote displays (5-7) for messages for broadcasting by a communication network (8). The audiovisual messages (4) received from the server system (1) are made perceptible for the clients (2, 3). The clients can send coded instruction signals (16) to a first access device (5a-7a), located near a display (5-7), by portable client badges (14, 15), which are transmitted to the server system (1) which then establishes a back-up communication (18) with the client (2), for example, through a portable telephone. The client can thus simply establish communication and, when the server system (1) has information specifically concerning the above, the information need not be transmitted over the network.

### TECHNICAL FIELD OF THE INVENTION

The present invention concerns devices for setting up calls between a customer and a service provider, both for communicating information to the customer and for transmitting orders to the service provider.

The customer generally receives advertising information from the service provider in the form of printed paper, advertising posters, or even broadcast advertising on a display screen. The customer must then choose a subject of interest from the received advertisements and enter into communication with the service provider to request additional information, place a purchase order, or perform any other activity. In setting up his call, the customer must provide a great deal of information, including in particular a description of the subject of interest, a statement of his intentions and his instructions, and an indication of the means of payment in the case of a purchase order, in addition to his civil status and the delivery address, his banking details, and proof of his ability to pay.

If the call set up by the customer to the service provider uses the worldwide network for communication between computers, the payment data must additionally be made secure to prevent it from being misused by third parties.

All of this complicates the operations to be performed by the customer, which slows down commercial transactions and increases the risk of error.

More recently there has been envisaged a simplified purchase order transmission system whereby the service provider stores most of the information relating to the customer and sends the customer audiovisual messages including a button which the customer may click to send a signal to the service provider, which generates the order itself. This limits information in transit on the network and facilitates the operations to be performed by the customer. However, the system is suitable only for placing an order and the messages that the service provider must transmit comprise an order instruction button and are therefore specific and more complex.

### SUMMARY OF THE INVENTION

The object of the present invention is to propose a new interactive communication device that facilitates the operations to be executed by the customer, facilitates the broadcasting of audiovisual messages from the service provider(s) to customers, limits the volumes of information transmitted over the networks for the various transactions, and is compatible with transactions that are more complex than a simple purchase instruction.

In particular, the invention must enable the customer to choose and trigger transactions merely by actuating a badge, without having to provide and transmit confidential information and without using a bank card with a PIN.

At the same time, the invention must make the transaction secure, to prevent a third party interfering with certain transactions.

To achieve the above and other objects, an interactive communication device of the invention comprises:
at least one server system having storage means containing an area for information relating to a plurality of customers, having an area for audiovisual broadcast messages, and having an interactive communication program,
a plurality of means for displaying audiovisual broadcast messages, located remotely from the server system,
a communication network, adapted to transmit audiovisual broadcast messages chosen by the program from the server system to the display means,
at least one first access means, placed in or near an associated display means,
at least one mobile customer badge assigned to a customer and adapted, in response to a specific action of the customer, to enter into the first access means a coded instruction signal containing a customer identification code and an instruction chosen by the customer from a plurality of possible instructions,
the first access means being adapted to transmit an instruction message that contains the instruction chosen by the customer, the customer identification code, and an identifier of the display means to the server system via the communication network.

In one advantageous embodiment, the display means are screens and electroacoustic transducers for the presentation of audiovisual messages placed in positions making them perceptible by customers.

To enable the customer to choose a specific instruction from a plurality of possible instructions, the mobile customer badge may advantageously comprise an input interface enabling the customer to enter an instruction chosen from the plurality of possible instructions by means of an appropriate specific action.

For example, the mobile customer badge may comprise a plurality of keys each corresponding to a specific instruction and which, when pressed, generate a coded instruction signal containing the corresponding specific instruction.

It may be advantageous for one of the keys to be operable more than once in succession to generate successively an order instruction and then a payment instruction. The same key may also switch on the mobile customer badge. It may be switched off automatically by a timer.

Security may be improved by the mobile customer badge comprising at least one key associated with a fingerprint recognition device and the device comprising means for inhibiting execution of the customer's specific instruction in the event of non-recognition of one or more fingerprints previously stored by the customer.

In a first embodiment:
the mobile customer badge is a magnetic stripe card, optical stripe card or microchip card in which the customer identification code is stored,
the first access means is a card reader adapted to read the customer identification code in the card presented to it.

In another embodiment:
the mobile customer badge is an electromagnetic signal sender adapted, in response to a specific action of the customer, to send the coded instruction signal in the form of a coded electromagnetic signal,
the first access means is an electromagnetic signal receiver adapted to receive said coded electromagnetic signal and to extract therefrom the customer identification code and the instruction corresponding to the specific action of the customer.

In the latter case, the mobile customer badge may be a dedicated device. Alternatively, it may be a cellular mobile telephone.

For improved communication between the customer and the first access means, it may be advantageous if:
the mobile customer badge is adapted to receive electromagnetic acknowledgement signals,
the first access means comprises a sender and means for generating and sending an electromagnetic acknowledgement signal after reception of a coded instruction signal coming from the mobile customer badge,
the mobile customer badge is adapted to send a status signal perceptible by the user and indicating if the first access means has received the coded instruction signal correctly.

In all the above situations, to establish a link between the audiovisual message perceived by the customer on a display means and the instruction that the customer wishes to give, it can be provided that.
a subroutine contained in said program instructs the server system to store the time of transmission to each display means of each broadcast audiovisual message,
on receiving an instruction message, the program of the server system combines the specific coded instruction signal, the identifier of the display means, the time of generation of the coded instruction signal, and the remainder of the broadcast messages to determine the broadcast audiovisual message that was being displayed at the time of generation of the coded instruction signal and to deduce therefrom the action to be performed by the return transmission means.

To make transactions more secure, in particular transactions having a non-negligible economic impact, it can be provided that:
the device comprises return transmission means adapted to set up directly to the customer a follow-up call from the server system or a service provider system designated by the server system,
the program of the server system is adapted to choose and set up the follow-up call as a function of the coded instruction signal received from the customer and as a function of information contained in the area for information relating to a plurality of customers.

The return transmission means may advantageously be the cellular mobile telephone network. The call for requesting more information, confirming an order, instructing shipping or any other transaction is then set up by telephone.

In one particular embodiment, the return transmission means is a means for transmitting text messages, such as the postal service, electronic mail, facsimile, electronic messages. This constitutes an alternative to the cellular mobile telephone.

### BRIEF DESCRIPTION OF THE DRAWINGS

Other objects, features and advantages of the present invention will emerge from the following description, which is given with reference to the appended drawings, in which:

FIG. 1 shows diagrammatically the architecture of one embodiment of an interactive communication device of the present invention; and

FIG. 2 shows the active face of a mobile customer badge used in one embodiment of the invention.

### DESCRIPTION OF THE PREFERRED EMBODIMENTS

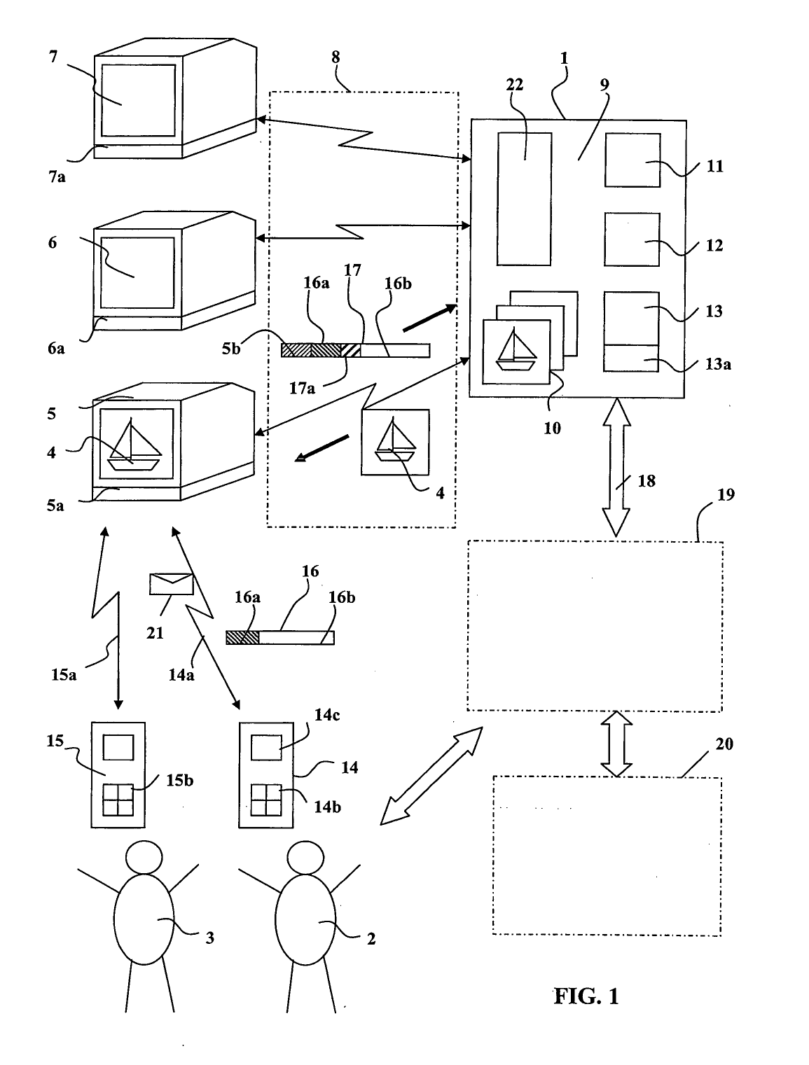

In the embodiment shown in FIG. 1, an interactive communication device of the invention provides communication between a server system 1 and a plurality of customers 2 and 3 shown diagrammatically.

The server system may communicate audiovisual messages 4 to the customers 2 and 3 via a plurality of means for displaying broadcast messages remote from the server system 1, such as the display means 5, 6 and 7. A communication network transmits audiovisual messages 4 to be broadcast chosen by a program that is stored in storage means 9 of the server system 1 from the server system 1 to the display means 5-7.

In practice, the storage means 9 contain an area 10 for the various broadcast messages, contain an area 11 for information relating to a plurality of customers, contain an area 12 for information relating to the means for displaying broadcast messages, and contain an interactive communication program 13 that controls a central unit 22.

Each display means 5-7 is associated with a display means identifier that identifies it unambiguously.

The device further comprises at least one first access means respectively 5a, 6a or 7a in the vicinity of an associated display means 5, 6 or 7. The first access means 5a-7a is adapted to receive from a customer 2 or 3 an instruction signal that it then transmits to the server system 1 via the communication network 8.

Each customer 2 or 3 may be provided with their own respective mobile customer badge respectively 14 or 15.

Each mobile customer badge 14 or 15 is adapted, in response to a specific action of the customer 2 or 3, to enter into the first access means 5a-7a a coded instruction signal 16 chosen by the customer 2 or 3 and containing a customer identification code 16a and a specific instruction 16b taken from a plurality of possible instructions.

The first access means 5a-7a transmits said coded instruction signal 16 to the server system 1 in the form of an instruction message 17 that contains the customer's instruction 16b, the customer identification code 16a, and additionally, in an area 5b, the identifier of the corresponding display means 5-7.

After receiving an instruction message 17, the server system 1 either executes the customer's instruction or starts by setting up a follow-up call 18 to the customer 2 or 3 via a return transmission means 19. The return transmission means 19 is adapted to set up directly a follow-up call to the customer 2 or 3 from the server system 1 or a service provider system 20 designated by the server system 1.

The program 13 of the server system 1 chooses and sets up the follow-up call 18 as a function of the coded instruction signal 16 received from the customer 2 or 3 in the instruction message 17: the program 13 finds in the coded instruction signal 16 the customer identification code 16a and may then extract the telephone coordinates of the customer concerned from the area 11 for information relating to the plurality of customers and use that information to instruct the return transmission means 19 to set up the follow-up call 18; the program 13 also finds the customer's instruction 16b in the coded instruction signal 16 and may then extract from the area 11 for information relating to the plurality of customers the additional data needed for following up the customer's instruction, for example credit data or authorizations needed to progress the customer's instruction.

The device of the invention is preferably programmed to manage less important transactions and more important transactions differently. Accordingly, the program 13 of the server system may be adapted to launch execution of the customer's specific instruction 16b directly, without setting up a follow-up call 18, if the instruction 16b involves a financial transaction in an amount below a predefined threshold. On the other hand, if the customer's specific instruction 16b involves a financial transaction in an amount above the predefined threshold, then the program 13 of the server system sets up the follow-up call 18 in order to verify the real intentions of the customer.

In the case of a follow-up call 18, it is advantageous for the server system 1 to comprise a voice recognition device associated with the return transmission means 19 and means for inhibiting execution of the specific instruction 16b in the event of non-recognition of the prerecorded voice of the customer 2 or 3.

The instruction message 17 may advantageously further include an area 17a containing an indication of the time at which the coded instruction signal 16 was sent. This enables a link to be established with the audiovisual message 4 that was being perceived by the customer 2 or 3 at the time he generated the coded instruction signal 16. To this end, the program 13 stored in the storage means 9 of the server system 1 comprises a subroutine 13a that instructs the server system 1 to store the time of transmission to each display means 5-7 of each broadcast audiovisual message 4.

For example, the display means 5-7 may be screens and electroacoustic transducers for presentation of audiovisual messages placed in positions making them perceptible by the customers 2 and 3. For example, the screen and electroacoustic transducers may be those of a conventional television set, a multimedia computer, a display panel, a product display, or any other equivalent device.

The display means 5-7 may be installed in public places, for example, or in customers' homes, and may in particular be connected to the server system 1 via the worldwide network for communication between computers, satellite, the switched telephone network, dedicated lines, the fiber optic cable network, wireless means or any other means.

The mobile customer badge 14 or 15 may also itself constitute a display means.

In a first embodiment, the mobile customer badge 14 or 15 may be a magnetic stripe card, an optical stripe card or a microchip card in which the customer identification code 16a is stored and which comprises at least one key for the customer to choose the specific instruction 16b to send, for example. The first access means 5a-7a may then comprise a card reader adapted to read the customer identification code 16a in the card 14 or 15 that is presented to it. To transmit an instruction to the server system 1, the customer 2 or 3 must then present his card 14 or 15 to the reader of the first access means 5a-7a and choose the specific instruction 16b.

In a preferred embodiment, the mobile customer badge 14 or 15 may comprise an electromagnetic signal sender adapted to send the coded instruction signal 16 in the form of a coded electromagnetic signal 14a or 15a in response to the actuation of a key 14b or 15b by the customer 2 or 3. The first access means 5a-7a then comprises an electromagnetic signal receiver adapted to receive said coded electromagnetic signal 14a or 15a and to extract from it the customer identification code 16a and the instruction 16b corresponding to the key 14b or 15b operated by the customer 2 or 3.

Depending on the applications envisaged, other access means 5a-7a may comprise a cash register, a coin or banknote dispenser, an automaton, a telephone.

The mobile customer badge 14 or 15 preferably comprises a plurality of keys, for example four keys as shown in the figure, each corresponding to a specific instruction and generating a coded instruction signal 16 containing a specific instruction.

For example, if the customer 2 presses a key 14b that causes the sending of a coded purchase instruction signal 16 and then the instruction message 17, the system associates the instruction message 17 with the audiovisual message 4 perceived by the customer 2 or 3 at the time he pressed the key 14b. Thus the server system 1 interprets the instruction message 17 as a purchase instruction relating to an object appearing on the screen 5 for which the first access means 5a has received the coded instruction signal 16 sent by the customer 2, for example. Where applicable, on receiving this instruction, the server system 1 sets up a follow-up call 18 to the customer 2 via the return transmission means 19.

For example, the return transmission means may be a means for transmitting text messages, such as the postal service, electronic mail, facsimile, electronic messages on cellular telephones. This transmission mode is suitable if the messages to be transmitted are relatively simple and do not have to be transmitted particularly quickly.

A return transmission means in the form of a cellular mobile telephone network may nevertheless be preferred. Direct communication with the customer 2 or 3 is then more reliable, and in this case it is advantageous to use the same, and appropriately programmed, cellular mobile telephone as the mobile customer badge 14 or 15.

In all situations in which the mobile customer badge 14 or 15 is adapted to emit electromagnetic signals, for example in the case of a cellular mobile telephone or an appropriate sender, it may be advantageous to provide means for displaying the transmission status. In this case, the mobile customer badge 14 or 15 may advantageously be adapted to receive electromagnetic acknowledgement signals sent by the first access means 5a-7a. To this end, the first access means 5a-7a comprises a sender and means for generating and sending an electromagnetic acknowledgement signal 21 after a coded instruction signal 16 is received from the mobile customer badge 14 or 15. At the same time, the mobile customer badge 14 or 15 sends a status signal 14c perceptible by the user and indicating whether the first access means 5a-7a has received the coded instruction signal 16 correctly.

For example, the mobile customer badge 14 or 15 may be programmed to send a “Received OK” status signal 14c if it has received the electromagnetic acknowledgement signal 21 shortly after the coded instruction signal 16 is sent or a “Not received OK” status signal 14c if it has not received the electromagnetic acknowledgement signal 21 within a predetermined time after a coded instruction signal 16 is sent.

The benefit of all embodiments of the invention is to enable the customer 2 or 3, merely by actuating his mobile customer badge 14 or 15, to give to the server system 1 sufficient specific instructions to perform a complex transaction such as a purchase and payment instruction, a request for more information, a shipping request, or various other services that may be provided by associated service providers.

It may further be advantageous for the mobile customer badge 14 or 15 to comprise an RPT key and storage means for temporarily storing the coded instruction signal 16 until an electromagnetic acknowledgement signal 21 is received if the electromagnetic acknowledgement signal 21 is not received, as soon as a “Not received OK” status signal 14c is sent, the RPT key is activated and the user may operate it to send the stored coded instruction signal 16 again. In particular, this facility solves the problems of collisions in the event of simultaneous sending of a plurality of coded instruction signals from a plurality of mobile customer badges 14 and 15 to the same first access means 5a.

Each means 5-7 for displaying broadcast messages may comprise a private surveillance video camera fixed above the screen, a small monitor or monitoring screen receiving images from the video camera, a sensor for detecting persons in the vicinity, and a plurality of first access means such as the first access means 5a.

The electromagnetic acknowledgement signal 21 may comprise an identity code of the first access means 5a-7a that sent it. This code may be displayed on the mobile customer badge 14 or 15.

The server system 1 may be programmed to set up quickly the follow-up call 18. Alternatively, the server system 1 may be programmed to defer setting up the follow-up call 18, thereby guaranteeing discretion or confidentiality.

A plurality of interactive sub-badges may be associated with a main mobile customer badge 14 or 15, for example issued to members of the same family.

Instead of this, or in addition to this, a plurality of customers may use the same mobile customer badge in succession. In this case, a biometric recognition means may be provided, such as a fingerprint recognition means, to inhibit the operation of the badge in the event of failure to recognize one of the prestored fingerprints, and the coded instruction signal 16 may contain the chosen instruction 16b, the customer identification code 16a, and an identification code of the mobile customer badge 14 or 15.

In the case of a mobile customer badge 14 or 15 in the form of a cellular mobile telephone, the cellular mobile telephone may advantageously be programmed to provide an encrypted access code, voice recognition to recognize the timbre of the voice of the usual customer, a personalized pseudonym, fingerprint recognition.

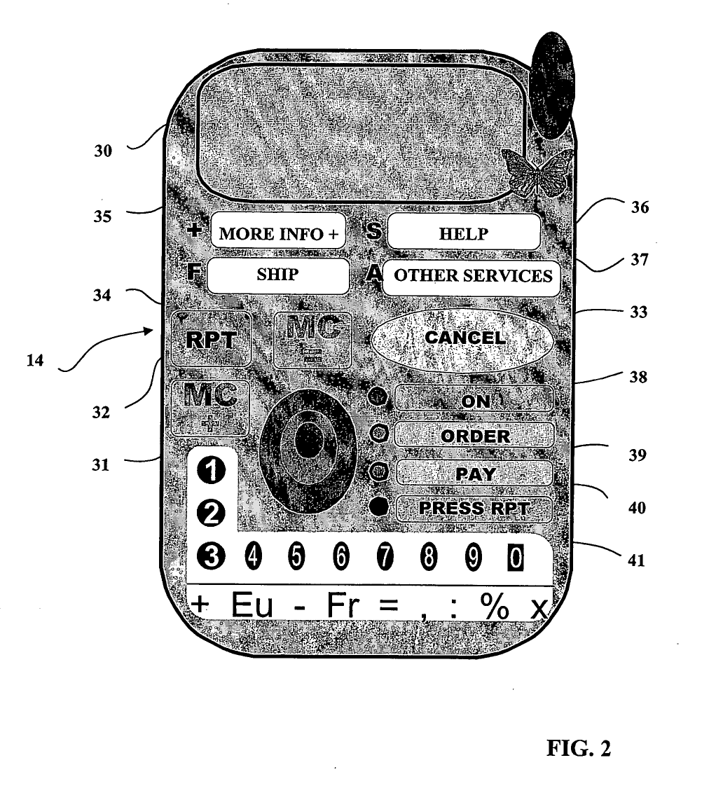

FIG. 2 shows one example of a mobile customer badge.

This mobile customer badge 14 takes the form of a calculator type unit comprising a display screen 30, which may be replaced with light-emitting diodes, and in particular a main key 31, an RPT key 32, a CANCEL key 33, a SHIP key 34, a MORE INFO key 35, a HELP key 36, and an OTHER SERVICES key 37.

The main key 31 constitutes, firstly, means for actuating the interface and, secondly, means for recognizing the fingerprint of the operator. The fingerprint of the customer is stored beforehand, either in the mobile customer badge or in the server system 1 if the corresponding information may be transmitted with the customer's instruction.

Pressing the main key 31 a first time switches on the mobile customer badge, and where applicable turns on a first light-emitting diode 38. Pressing the main key 31 again sends an order instruction and turns on a second light-emitting diode 39. Pressing the main key 31 again sends a payment instruction and turns on a third light-emitting diode 40.

A greater number of dedicated instructions may be provided by assigning certain dedicated instructions a combination of keys to be actuated simultaneously or in succession.

If the mobile customer badge 14 does not receive an acknowledgement of the instruction that has been sent to the nearby access means, the mobile customer badge generates a visual message by turning on a diode 41, prompting the customer to press the RPT key 32 to generate the instruction again.

Note that the fingerprint recognition device may be replaced by any other biometric recognition means.

It may be useful to modify the customer identification code 16a periodically. One option is as follows:
the mobile customer badge contains a stack of customer identification codes 16a stored in a random order in a memory of the badge,
the server system 1 contains the same stack of customer identification codes stored in the same random order in a memory of the server,
with each dedicated instruction 16b that the customer decides to send, the mobile customer badge 14 associates the next higher customer identification code 16a in the stack of customer identification codes,
on each reception of an instruction message 17, the server system 1 compares the customer identification code 16a received with the next higher customer identification code in its own stack of customer identification codes and inhibits execution of the customer's dedicated instruction 16b if they are different.

Another option is for the coded instruction signals 16 and/or the instruction messages 17 to be encrypted using from 128 to 448 bits and keys distributed in a random selection mode with the rate of distribution of keys modifiable and adjustable.

The operation of the device of the invention may be summarized in the following manner in the case of an order instruction.

When he sees on the display means 5 an audiovisual message 4 of interest, the customer 2 presses the key 14b relating to an order instruction. The mobile customer badge 14 then sends a coded instruction signal 16 to the first access means 5a. Either immediately or later, the first access means 5a generates an instruction message 17 that is sent to the server system 1, which verifies the data of the message: it verifies the customer identification code 16a against the area 11 for information on the plurality of customers, it verifies the identifier of the display means 5b against the area for means for displaying broadcast messages 12, and it searches for the audiovisual message 4 in the area 10 for broadcast messages as a function of the time at which the coded instruction signal 17a was generated. Immediately or later, the server system 1 then generates a telephone call to the mobile telephone 14 of the customer 2 to validate the order, program shipment and on-line follow-up, and record the total payment.

When he presses a dedicated key to send an information request message, the mobile customer badge 14 of the customer 2 generates a different dedicated coded instruction signal that is transmitted to the server system 1 in the same way and is interpreted by the server system 1 in order to set up quickly a follow-up call 18 for transmitting the required information to the customer.

A similar mode of operation may be provided for the situation where the customer 2 presses a key relating to a shipping instruction.

If the customer 2 presses a key for another service, the server system 1 interprets the signal received to set up a call between a service provider system 20 and the customer 2.

Giving the device an additional help function may be envisaged. To this end, a dedicated key on the mobile customer badge 14 is assigned, actuation of this key generating a dedicated coded instruction signal 16 that is received by the server system 1, which immediately generates a telephone call to the mobile telephone of the customer 2. If it is not possible to set up the call, then the server system 1 generates a telephone or fax call or an electronic mail that is transmitted directly to the law enforcement agency nearest the first access means 5a-7a that has received the signal from the customer 2. The message sent to the law enforcement agency contains full information on the customer and the geographical location of the access means 5a-7a, in order for intervention to be expedited immediately to the appropriate place and as quickly as possible.

The present invention is not limited to the embodiments that have been described explicitly and includes variants and generalizations thereof that fall within the scope of the following claims.

1-18. (canceled)

19. An interactive communication device comprising:
at least one server system, said server system having storage means containing an area for information relating to a plurality of customers,
a means placed at a distance from the server system for displaying broadcast audiovisual messages,
a communication network between the server system and the display means,
at least one first access means placed in or near a display means with which it is associated,
at least one mobile customer badge assigned to a customer and adapted, in response to a specific action of the customer, to enter into the first access means an instruction signal coming from the customer,
wherein:
the area for information relating to a plurality of customers contains additional data necessary for following up customer instructions,
the storage means contain an area for broadcast audiovisual messages,
the storage means contain an interactive communication program,
the interactive communication device comprises a plurality of means for displaying individual broadcast messages,
the communication network is adapted to transmit broadcast audiovisual messages chosen by the program from the server system to the display means,
the instruction signal is a coded instruction signal containing a customer identification code and an instruction chosen by the customer from a plurality of possible instructions, and
the first access means transmits to the server system via the communication network an instruction message that contains the instruction chosen by the customer, the customer identification code and an identifier of the display means.

20. The interactive communication device according to claim 19, wherein the display means are screens and electroacoustic transducers for presenting audiovisual messages placed at positions making them perceptible by the customers.

21. The interactive communication device according to claim 19, wherein the mobile customer badge comprises an input interface enabling the customer to enter an instruction chosen from a plurality of possible instructions by an appropriate specific action.

22. The interactive communication device according to claim 21, wherein the mobile customer badge comprises a plurality of keys each corresponding to a specific instruction and which, when pressed, generate a coded instruction signal containing the corresponding specific instruction.

23. The interactive communication device according to claim 22, wherein one of the keys may be operated more than once in succession to generate successively an order instruction and then a payment instruction.

24. The interactive communication device according to claim 22, wherein the mobile customer badge comprises at least one key associated with a fingerprint recognition device and the device comprises means for inhibiting execution of the specific instruction in the event of non-recognition of one or more fingerprints previously stored by the customer.

25. The interactive communication device according to claim 21, wherein:
the mobile customer badge is a magnetic stripe card, an optical stripe card or a microchip card in which the customer identification code is stored,
the first access means is a card reader adapted to read the customer identification code in a card that is presented to it.

26. The interactive communication device according to claim 21, wherein:
the mobile customer badge comprises an electromagnetic signal sender adapted to send the coded instruction signal in the form of a coded electromagnetic signal in response to a specific action of the customer, and
the first access means is an electromagnetic signal receiver adapted to receive said coded electromagnetic signal and to extract therefrom the customer identification code and the instruction corresponding to the specific action of the customer.

27. The interactive communication device according to claim 26, wherein the mobile customer badge is a cellular mobile telephone.

28. The interactive communication device according to claim 26, wherein:
the mobile customer badge is adapted to receive electromagnetic acknowledgment signals,
the first access means comprises a sender and means for generating and sending an electromagnetic acknowledgment signal after reception of a coded instruction signal from the mobile customer badge, and
the mobile customer badge is adapted to emit a status signal perceptible by the user and indicating whether the first access means has received the coded instruction signal correctly.

29. The interactive communication device according to claim 19, wherein:
it comprises a return transmission means adapted to set up directly a follow-up call to the customer from the server system or a service provider system designated by the server system,
the program of the server system is adapted to choose and to set up the follow-up call as a function of the coded instruction signal received from the customer and information contained in the area for information relating to a plurality of customers.

30. The interactive communication device according to claim 29, wherein the return transmission means is the cellular mobile telephone network of the cellular mobile telephone.

31. The interactive communication device according to claim 29, wherein the return transmission means is a means for transmitting text messages, such as the postal service, electronic mail, facsimile, electronic messages.

32. The interactive communication device according to claim 29, wherein the program of the server system launches the execution of the customer's specific instruction directly without setting up a follow-up call if the instruction involves a financial transaction whose amount is below a predefined threshold.

33. The interactive communication device according to claim 29, wherein the server system comprises a voice recognition device associated with the return transmission means and means for inhibiting execution of the specific instruction in the event of non-recognition of the previously recorded voice of the customer.

34. The interactive communication device according to claim 19, wherein:
a subroutine contained in said program instructs the server system to store the time of transmission to each display means of each broadcast audiovisual message,
on receiving an instruction message, the program of the server system combines the specific coded instruction signal, the identifier of the display means, the time of generation of the coded instruction signal and the remainder of the broadcast messages to determine the broadcast audiovisual message that was being displayed at the time of generation of the coded instruction signal and to deduce therefrom the action to be performed.

35. The interactive communication device according to claim 19, wherein:
the mobile customer badge contains a stack of customer identification codes stored in a memory of the badge in a random order,
the server system contains the same stack of customer identification codes stored in the same random order in a memory of the server,
the mobile customer badge associates with each specific instruction the next higher customer identification code in the stack of customer identification codes, and
on each reception of an instruction message, the server system compares the customer identification code received with the next higher customer identification code in its own stack of customer identification codes and inhibits execution of the customer's specific instruction if they are different.

36. The interactive communication device according to claim 19, wherein the coded instruction signals and/or the instruction messages are encrypted using keys distributed in a random selection mode.
